(19) United States
(12) Patent Application Publication
(10) Pub. No.: US 2004/0110850 A1
(43) Pub. Date: Jun. 10, 2004

(54) Wax composition and method of applying same to a wet surface

(76) Inventors: Elsie A. Jordan, Temecula, CA (US); Chad H. Heath, San Diego, CA (US)

Correspondence Address: CARRITHERS LAW OFFICE, One Paragon Centre, Suite 140, 6060 Dutchman's Lane, Louisville, KY, 40205, US

(21) Appl. No.: 10/314,446

(22) Filed: Dec. 9, 2002

(51) Int. Cl. B01F 17/00

(52) U.S. Cl. 516/55

(57) ABSTRACT

A high water content silicone containing wax composition for application to a vehicle's exterior surfaces that is applied while the surface is still wet from rinsing with water and then wiped with an absorbent material to simultaneously dry and buff the waxed surface.

### BACKGROUND OF THE INVENTION

1. Technical Field

This invention relates to a high water content silicone wax composition that protects and provides a high gloss on automobile exterior surfaces and is applied to a clean water wet surface.

2. Description of the Prior Art

There are numerous wax products available on the market to protect and polish the painted body surfaces of an automobile and also various different ways of applying the same. The most recommended procedure is to wash and dry the painted surface, apply the protective finish to the clean dry surface, and then buff the surface. The applied wax remains as a protective finish throughout several subsequent washes but it is a time consuming labor intensive procedure.

A quick wax job is obtainable in an automatic or semiautomatic car-wash where a detergent is applied to the surface of the vehicle under high water pressure and/or using a water and detergent solution together with strips of absorbent material or sponges to remove the dirt. As part of the car-wash liquid wax may be sprayed onto the vehicle and allowed to drip dry or be dried using an air blower. The wax compositions used by professional car washes that are applied while the automobile painted surface is wet are immediately subjected to a blow dry step and is not buffed. Neither of the latter two wax compositions and procedures of applying the same provide long lasting satisfactory results.

Conventional commercial waxes and polishes typically contain a wax dispersed in water or dissolved in a solvent often together with abrasives for dry application to a painted surface of a automobile. The wax dries and is removed with hand or mechanical buffing machines requiring considerable labor and time.

Two references considered of interest with respect to applicants wax composition are U.S. Pat. No. 6,103,323 issued in January of 2000 to D. W. Klayder et al which teaches silicone gel waxes and protectants; and U.S. Pat. No. 5,700,312 issued in December of 1997 to R. L. Fausnight et al. which teach wax dispersed in a silicone liquid. The Fausnight et al. reference utilizes a micronized wax with an emulsifier in order to disperse the wax in a water/organic solvent emulsion containing a silicone liquid in both the organic and aqueous phases for application to a dry surface and does not require rubbing or buffing.

### SUMMARY OF THE INVENTION

A principal object of the present invention is to provide a wax composition and procedure of applying the same to a wet surface in order to eliminate a drying step between the washing and buffing steps. The composition is formulated to achieve a product which readily separates in to phases upon application by spraying onto a wetted surface providing a thin film of wax providing the desired coating of the surface.

The instant invention is the first product designed to wax a vehicle as it is dried off after washing. Simply spray the wax composition onto the wet vehicle and dry the vehicle with a soft cloth to leave a lustrious shine and protective coating of wax.

The instant claimed invention does not require that the wax be micronized, nor does it require a low boiling solvent. Selected constituents comprising the formulation of Applicant's instant invention are added as emulsified components; however, the formulated product is a blend of components mixed together, and is not dependent upon use of an emulsifier in order to disperse all of the various components together in the final product as is taught by conventional waxes applied to a dry surface.

In keeping with this object there is provided in accordance with the present invention a high water content silicone wax composition for use on vehicular exterior painted metal or painted plastic surface, chrome, stainless steel, plastic moldings, vinyl tops and trim, fiberglass, and/or rubber surfaces. Moreover, the method of applying the same consists of wetting a cleaned surface to be waxed, spraying the wax composition onto the wet surface and wiping the surface with a piece of absorbent material to simultaneously dry and buff the same. Of course, the instant formulation is ready to apply to a vehicle which has just been rinsed after washing.

These an other objects and features of the invention will become apparent to those skilled in the art from the following detailed description and appended claims.

### DESCRIPTION OF THE PREFERRED EMBODIMENT

The instant invention is particularly directed to reducing the effort of providing a glossy finish on the painted exterior surface of a vehicle such as an automobile or the like by combining the step of drying, after washing and rinsing, and the step of buffing the wax into a single step operation. To clean the exterior surface of the automobile it is washed in a conventional manner using appropriate conventional cleaning agents such as detergents in the water and the surface is then rinsed using clean water. While still wet from the rinsing the above composition is sprayed lightly onto the surface to be waxed. The waxed surface is then wiped with a cloth, or equivalent absorbent material, to dry the surface and in so doing at the same time the waxed surface is buffed. The conventional step of drying after rinsing and before applying the wax is eliminated.

One preferred embodiment of the instant invention comprises a wax composition utilizing a selected amount of blended components and solvent for providing a controlled low evaporation rate upon application to a water wet surface. The preferred wax composition is a high water content wax dispersion composed of a carnauba wax emulsion in an amount of about 0.05 percent by weight; a silicone emulsion comprising a liquid dimethyl polysiloxane in an amount of about 2.77 percent; SILWET L 7607, a polyalkylene oxide-modified polydimethylsiloxane block copolymer in an amount of about 0.22 weight percent; ISOPAR M, an isoparaffinic solvent in an amount of about 5.55 percent by weight; a propylene glycol in an amount of about 1.79 percent by weight; and a major amount of water, soft or demineralized, of about 89 percent by weight. One of more fragrances can be optionally added in an amount of about 0.20 percent by weight. Also, it is recommended to add a biocide such as DANTOGARD in an amount of about 0.12 percent by weight.

The resulting composition is a white liquid emulsion having a brix of about 2.6, solid contents of about 2.9-3.0 percent. Application to a wetted painted surface or other wetted surface to be treated by spraying, results in an easy wiping and removal of excess product from the surface resulting in a glossy surface without streaks.

The above composition is applied to a vehicle by wetting a cleaned surface using clean water. The foregoing composition is sprayed lightly onto the wet surface and the surface is then wiped with a cloth, sponge, and/or other absorbent material to dry and simultaneously buff the same. It should be noted that the composition is not added to the rinse water as taught by conventional car washes or applied to a dry surface.

A silicone comprising a liquid dimethyl polysiloxane is used in the present invention. The dimethyl polysiloxane emulsion is typically obtained commercially in a 60% emulsion which is added to the blend of other constituents and mixed together to form the final wax composition. Dimethyl polysiloxane is sold by Dow Corning under the trademark 346 EMULSION 60% or sold by General Electric under the trademark SM2163 60%. An effective amount of the dimethyl polysiloxane 60% of up to 15 percent by weight can be used in the present invention and more particularly in a range of from 0.01 to about 10.0 percent by weight, more particularly in a range of from about 0.1 to about 8.0 percent by weight, and more particularly from about 1.0 to 5.0 percent by weight based on the total weight of the composition. One preferred embodiment uses an effective amount of dimethyl polysiloxane 60% emulsion in an amount of 2.8 percent by weight.

A humectant which is hygroscopic provides a stabilizing action to keep the moisture content within a desired range and minimize humidity fluctuations. It aids in dispersion and clarity of the wax. A preferred humectant contains alcohol groups and is a glycol compound selected from the group including ethylene glycol, diethylene glycol, propylene glycol, methyl alcohol, ethyl alcohol, propyl alcohol, isopropyl alcohol, glycerol, and combinations thereof. The humectant is added in an effective amount up to 10 percent by weight, more preferably in a range of from between 0.1 to 8.0 percent by weight, more preferably in a range of from 1.0 to 5.0 percent by weight, more preferably in a range of from between 1.0 to 3.0 percent by weight based on the total weight of the composition. One preferred embodiment of the present invention includes about 1.8 percent by weight of propylene glycol based on the total weight of the composition.

An organic solvent is added to the wax composition to aid in cleansing and aid in the removal of residual water upon application of the product on a wetted surface. Organic solvents useful in the present invention include isoparaffins, aliphatic hydrogen solvents, parafinnic solvents, paraffins, synthetic isoparaffinic solvents. One preferred organic solvent is sold under the tradename of ISOPAR M which is a synthetically produced isoparaffinic solvent sold by ExxonMobil Chemical Company. It is contemplated that ISOPAR V would also exhibit acceptable performance as well. The isoparaffinic solvents are highly aliphatic compounds containing a high percentage of isoparaffins. The organic solvents used in the present invention are typically considered high boiling solvents having a low vapor pressure typically less than 1.0 mm Hg at 20° C. and preferably 0.1 mm Hg or less at 20° C. Furthermore, the most preferred ISOPAR solvents reportedly have a vapor pressure of about 10 mm Hg at 38° C. and more preferably have a vapor pressure of about 4 mm Hg at 38° C. The high boiling solvent is added in an effective amount up to 25 percent by weight, more preferably in a range of from between 0.01 to 15.0 percent by weight, more preferably in a range of from 0.1 to 10.0 percent by weight, more preferably in a range of from between 1.0 to 8.0 percent by weight based on the total weight of the composition. One preferred embodiment of the present invention includes about 5.6 percent by weight of ISOPAR M based on the total weight of the composition blend.

The preferred wax component is carnauba wax. Of course, candelilla or ozokerite wax could be utilized in the present invention as well. Moreover, it is contemplated that synthetic waxes such as polyethylene wax, polypropylene wax, polyamide wax, and combinations thereof can also be utilized in the instant invention. The instant invention does not require that the wax be micronized which is a process whereby waxes are cryogenically ground to fine particles of typically less than 20 microns. Conventional commercial wax preparations of greater than 20 microns are adequately dispersed in the present invention. Moreover, th micronization process is considerably more expensive than commercial available waxes processed in the conventional manner. The wax is provided as an emulsion, typically a nonionic or anionic emulsion consisting of about 40 percent by weight wax and 60 percent by weight of an emulsion consisting of water and emulsifier. Of course the wax could be obtained dry and dispersed within the blend of components separately from the emulsion providing the same functional qualities; however, it is more convenient to obtain the wax in the form of a 60% emulsion from commercial vendors. The wax emulsion consisting of about 40% wax and 609 emulsion is added to the wax composition blend in an effective amount to form a thin film on a wetted surface upon buffing, ranging from 0.001 to 6.0 percent by weight, and more preferably in a range of from 0.01 to 1.0 percent by weight, and more preferably in a range of from between 0.01 and 0.1 percent by weight based on the total weight of the composition. One preferred embodiment uses 0.05 percent by weight of a carnauba emulsion.

A silicone surfactant, such as SILWET 7607, a polyalkylene oxide-modified polydimethylsiloxane block copolymer, product commercially available from Osi. Other suitable oxide modified polydimethylenesiloxanes are SILWET L 7602 and SILWET 7606, by Osi. The aforementioned SILWET compounds have a molecular weight of about 3,000 and an aqueous surface tension of about 26.6 Dynes/cm at 0.1% by weight aqueous solution. The silicone surfactant is used as a surface-active agent in an effective amount to reduce the interfacial tension between the treated waxed surface and water. The selection and amount of the silicone surfactant is important in order to obtain a controlled low evaporation rate to the residual water from the treated surface. The silicone surfactant composition is added in an effective amount ranging of from 0.01 to 5.0 percent by weight, and more preferably in a range of from 0.1 to 1.0 percent by weight, and more preferably in a range of from between 0.1 to 0.5 percent by weight based on the total weight of the composition. One preferred embodiment uses 0.22 percent by weight of a polyalkylene oxide-modified polydimethylsiloxane block copolymer in the blended composition.

A biocide, such as DANTOGARD (DMDM Hydantoin) or TROYSAN 395 is optionally used as a preservative in the product. The biocide is not a necessary component to provide a functional wax composition for use on wetted surfaces; however, the preservative provides a useful shelf life to the product. The biocide preservative is added in an effective amount to preserve the wax composition product and ranges from 0.01 to 2.0 percent by weight, and more preferably in a range of from 0.05 to 1.0 percent by weight, and more preferably in a range of from between 0.1 and 0.5 percent by weight based on the total weight of the composition. One preferred embodiment uses 0.12 percent by weight of a DANTOGARD in the wax composition. Other preservatives such as polymethoxybicyclic oxazolidine may also be useful in the present invention.

A major amount of water is added to the wax composition blend of the instant invention as a carrier. Preferably the water is soft or demineralized and is present in an amount of up to 96 percent by weight, and more preferably of from between 75 to 95 percent by weight, and more preferably of from between 85 to 92 percent by weight. One preferred embodiment contains about 89 percent by weight water based on the total weight percent of the composition.

Although not required, an effective amount of one or more fragrances, such as vanilla, bubble gum, orange, limonene, and the like may be added to the instant invention to impart a desirable scent to the product. Preferably the fragrance is present in an amount of up to 2 percent by weight, and more preferably of from between 0.001 to 1.0 percent by weight, and more preferably of from between 0.01 to 0.5 percent by weight. One preferred embodiment contains about 0.06 percent by weight of bubble gum flavor and about 0.14 percent by weight of vanilla flavor based on the total weight percent of the composition.

One preferred formula for the wax composition of the present invention is set forth in Table I as follows:

TABLE I

| Constituent | Commercial Name | Percent by Weight |
|---|---|---|
| Water | | 89.3 |
| Dimethyl polysiloxane | G.E. SM 2163 60% | 2.8 |
| Silicone Surfactant | SILWET 7607 | 0.2 |
| Isoparaffinic solvent | ISOPAR M | 5.6 |
| Humectant | Propylene Glycol | 1.8 |
| Biocide | DANTOGARD | 0.1 |
| Wax | Carnauba Emulsion 60% | 0.05 |
| Fragrance | Vanilla | 0.15 |

Dyes, fungicides, and/or colorants may also be added to the wax composition in an effective amounts of less than 1 percent by weight based on the total weight of the composition.

A pressurized liquid propellant may be utilized as a carrier to apply the film coating lubricant. One preferred embodiment of the present invention uses a nonfluorinated propellant. A commercial liquid hydrocarbon propellant which is compatible with the preferred composition may be selected from the group of A-31, A-46, A-70, or A-108 propane/isobutane blends, with A-46 and A-70 being the most preferred propellant for use with particular compositions. The composition contains an effective amount of propellant. For instance, one embodiment may contain up to 25 weight percent of the propellant, and more preferably from 5 to 20 weight percent of the propellant based on the total weight of the composition.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

We claim:

1. A wax composition, comprising:
a silicone emulsion comprising a liquid dimethylpolysiloxane in an amount of about 2.8 percent by weight;
a polyalkylene oxide-modified polydimethylsiloxane block copolymer product in an amount of about 0.2 percent by weight;
an isoparaffinic solvent in an amount of about 5.6 percent by weight;
a propylene glycol in an amount of about 1.8 percent by weight;
a biocide in an amount of about 0.1 percent by weight;
a carnauba emulsion in an amount of about 0.050 percent by weight;
is a major amount of water;
wherein said wax composition is applied to a wetted surface to be treated and wiped off leaving a film of wax thereon.

2. The wax composition of claim 1, wherein said polyalkylene oxide-modified polydimethylsiloxane block copolymer is SILWET L 7607.

3. The wax composition of claim 1, wherein said isoparaffinic solvent is ISOPAR M.

4. The wax composition of claim 1, including a fragrance in an amount of about 0.2 percent by weight.

5. The wax composition of claim 1, wherein said biocide is DANTOGARD.

6. A method of waxing a surface comprising the steps of:
(a) providing a clean surface to be waxed
(b) wetting said surface with clean water;
(c) spraying the composition of claim 1 onto said wet surface resulting in a wet waxed surface; and
(d) wiping said wet waxed surface with a piece of absorbent material to simultaneously dry and buff the same.

7. The method of claim 6, wherein said surface comprises the painted surface of a vehicle.

8. The method of claim 6, wherein said step of providing a clean surface to be waxed includes washing said surface with water containing a conventional suitable cleaning agent and rinsing said washed surface with clean water to thereby provide said clean wetted surface to be waxed.

9. A wax composition, consisting essentially of:
an effective amount of a liquid dimethylpolysiloxane;
an effective amount of a silicone surfactant
an effective amount of an isoparaffinic solvent;
an effective amount of a humectant;
an effective amount of a carnauba wax emulsion 60%;
a major amount of water; and
wherein said wax composition is applied to a wetted surface to be treated and wiped off leaving a film of wax thereon.

10. The wax composition of claim 9, wherein an effective amount of said liquid dimethylpolysiloxane is from 0.1 to 10.0 percent by weight.

11. The wax composition of claim 9, wherein an effective amount of said silicone surfactant is from 0.01 to 5.0 percent by weight.

12. The wax composition of claim 9, wherein said silicone surfactant comprises a polyalkylene oxide-modified polydimethylsiloxane block copolymer.

13. The wax composition of claim 9, wherein an effective amount of said isoparaffinic solvent is from 0.1 to 15.0 percent by weight.

14. The wax composition of claim 9, wherein an effective amount of said humectant is from 0.1 to 8.0 percent by weight.

15. The wax composition of claim 9, wherein said humectant comprises a propylene glycol.

16. The wax composition of claim 9, wherein said carnauba wax emulsion 60% is present in an amount of from 0.001 to 5.0 percent by weight.

17. The wax composition of claim 9 including an effective amount of a biocide.

18. The wax composition of claim 17, wherein said effective amount of a biocide is from about 0.01 to 1.0 percent by weight.

19. The wax composition of claim 9 including a fragrance.

20. The wax composition of claim 19, wherein said fragrance is present in an amount of from between 0.001 and 1.0 percent by weight.

21. A wax composition, consisting essentially of:
a silicone emulsion comprising a liquid dimethylpolysiloxane in an amount of about 2.8 percent by weight;
a polyalkylene oxide-modified polydimethylsiloxane block copolymer product in an amount of about 0.2 percent by weight;
an isoparaffinic solvent in an amount of about 5.6 percent by weight;
a propylene glycol in an amount of about 1.8 percent by weight;
a biocide in an amount of about 0.1 percent by weight;
a carnauba emulsion in an amount of about 0.050 percent by weight; and
a major amount of water.
